(19) United States
(12) Patent Application Publication
(10) Pub. No.: US 2024/0196416 A1
(43) Pub. Date: Jun. 13, 2024

(54) SIDELINK TRANSMISSION CONFIGURATION INDICATOR (TCI) STATE COMMAND CONFLICT RESOLUTION

(71) Applicant: QUALCOMM Incorporated, San Diego, CA (US)

(72) Inventors: Hua Wang, Basking Ridge, NJ (US); Sony Akkarakaran, Poway, CA (US); Qing Li, Princeton Junction, NJ (US); Yan Zhou, San Diego, CA (US); Jelena Damnjanovic, Del Mar, CA (US); Jung Ho Ryu, Fort Lee, NJ (US); Tao Luo, San Diego, CA (US)

(21) Appl. No.: 18/064,236

(22) Filed: Dec. 9, 2022

(51) Int. Cl. H04W 72/25; H04L 5/00; H04W 72/563

(52) U.S. Cl. CPC H04W 72/25; H04L 5/0053; H04W 72/563

(57) ABSTRACT

Methods, systems, and devices for wireless communications are described. In some cases, a first user equipment (UE) may transmit, to a second UE, first control information indicating a first transmission configuration indicator (TCI) state for use in sidelink communications between the first UE and the second UE. The first UE may receive, from the second UE, second control information indicating a second TCI state for use in sidelink communications between the first UE and the second UE, where a first application time of the first TCI state conflicts with a second application time of the second TCI state. The first UE may select, in accordance with one or more rules for resolving sidelink TCI state conflicts, one of the first TCI state or the second TCI state as a selected TCI state. Accordingly, the first UE may communicate with the second UE in accordance with the selected TCI state.

### FIELD OF TECHNOLOGY

The following relates to wireless communications, including sidelink transmission configuration indicator (TCI) state command conflict resolution.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sidelink transmission configuration indicator (TCI) state command conflict resolution. Generally, the techniques described herein may enable one or more user equipments (UEs) to avoid or resolve TCI state command confliction in sidelink communications. For example, a first UE may be in sidelink communications with a second UE and each UE may receive first control information that indicates a limitation to transmission of a potential TCI state, where the limitation restricts the first UE and the second UE from simultaneously applying different potential TCI states during the sidelink communications. In some examples, the limitation may define that only the first UE or the second UE is to transmit the potential TCI state. Additionally, or alternatively, the limitation may define that all potential TCI states used during the sidelink communications have a same time threshold for application of the potential TCI states. As such, the first UE may transmit, to the second UE, an indication of a first TCI state in accordance with the limitation and the UEs may communicate in accordance with the first TCI state.

Additionally, or alternatively, the first UE may transmit, to the second UE, first control information that indicates a first TCI state for use in the sidelink communications between the first UE and the second UE and may receive, from the second UE, second control information that indicates a second TCI state for use in the sidelink communications between the first UE and the second UE. Accordingly, the first UE and the second UE may select one of the first TCI state or the second TCI state as a selected TCI state based on one or more rules for resolving sidelink TCI state conflicts. In some examples, the one or more rules may define that the selected TCI state is selected based on a comparison of a first priority associated with the first UE and a second priority associated with the second UE. Additionally, or alternatively, the one or more rules may define that the selected TCI state is selected based on a comparison of a first timing of a first acknowledgement message received in response to the first control information and a second timing of a second acknowledgement message transmitted in response to the second control information. As such, the first UE and the second UE may communicate in accordance with the selected TCI state.

A method for wireless communications at a first UE is described. The method may include receiving first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, transmitting, to the second UE, an indication of a first TCI state in accordance with the limitation, and communicating with the second UE in accordance with the first TCI state.

An apparatus for wireless communications at a first UE is described. The apparatus may include a processor, memory coupled with the processor, and instructions stored in the memory. The instructions may be executable by the processor to cause the apparatus to receive first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, transmit, to the second UE, an indication of a first TCI state in accordance with the limitation, and communicate with the second UE in accordance with the first TCI state.

Another apparatus for wireless communications at a first UE is described. The apparatus may include means for receiving first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, means for transmitting, to the second UE, an indication of a first TCI state in accordance with the limitation, and means for communicating with the second UE in accordance with the first TCI state.

A non-transitory computer-readable medium storing code for wireless communications at a first UE is described. The code may include instructions executable by a processor to receive first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, transmit, to the second UE, an indication of a first TCI state in accordance with the limitation, and communicate with the second UE in accordance with the first TCI state.

In some examples of the method, apparatuses, and non-transitory computer-readable medium described herein, the limitation defines that only one of the first UE or the second UE may be to transmit the potential TCI state.

Some examples of the method, apparatuses, and non-transitory computer-readable medium described herein may further include operations, features, means, or instructions for receiving, from the second UE, an indication of assistance information associated with the sidelink communications between the first UE and the second UE and determining the first TCI state based on the assistance information.

Some examples of the method, apparatuses, and non-transitory computer-readable medium described herein may further include operations, features, means, or instructions for determining that a type of the first UE matches a designated UE type specified by the limitation, the designated UE type representative of UEs allowed to transmit the potential TCI state in accordance with the limitation.

In some examples of the method, apparatuses, and non-transitory computer-readable medium described herein, the designated UE type may be a RSU or a PLC.

In some examples of the method, apparatuses, and non-transitory computer-readable medium described herein, the limitation defines that all potential TCI states used during the sidelink communications may have a same time threshold for application of the potential TCI states.

Some examples of the method, apparatuses, and non-transitory computer-readable medium described herein may further include operations, features, means, or instructions for receiving, from the second UE, an acknowledgement message associated with the indication from the first UE of the first TCI state and applying the first TCI state to the sidelink communications with the second UE after receipt of the acknowledgement message and after the time threshold.

In some examples of the method, apparatuses, and non-transitory computer-readable medium described herein, the time threshold may be defined in the first control information as a quantity of symbols that follows receipt of an acknowledgement message responsive to transmission of the indication of the first TCI state.

Some examples of the method, apparatuses, and non-transitory computer-readable medium described herein may further include operations, features, means, or instructions for receiving, from the second UE, a second indication of a second TCI state, transmitting, to the second UE, a second acknowledgement message associated with the second indication from the second UE of the second TCI state, and communicating with the second UE in accordance with the second TCI state after transmission of the second acknowledgement message and after the time threshold.

In some examples of the method, apparatuses, and non-transitory computer-readable medium described herein, communicating with the second UE in accordance with the second TCI state may include operations, features, means, or instructions for switching from communicating in accordance with the first TCI state to communicating in accordance with the second TCI state.

In some examples of the method, apparatuses, and non-transitory computer-readable medium described herein, the first UE communicates according to a TDM communication scheme.

A method for wireless communications at a first UE is described. The method may include receiving first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, receiving, from the first UE, an indication of a first TCI state in accordance with the limitation, and communicating with the first UE in accordance with the first TCI state.

An apparatus for wireless communications at a first UE is described. The apparatus may include a processor, memory coupled with the processor, and instructions stored in the memory. The instructions may be executable by the processor to cause the apparatus to receive first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, receive, from the first UE, an indication of a first TCI state in accordance with the limitation, and communicate with the first UE in accordance with the first TCI state.

Another apparatus for wireless communications at a first UE is described. The apparatus may include means for receiving first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, means for receiving, from the first UE, an indication of a first TCI state in accordance with the limitation, and means for communicating with the first UE in accordance with the first TCI state.

A non-transitory computer-readable medium storing code for wireless communications at a first UE is described. The code may include instructions executable by a processor to receive first control information that is indicative of a limitation to transmission, by a sidelink UE, of a potential TCI state, where the limitation restricts the first UE and a second UE in sidelink communications with the first UE from simultaneously applying different potential transmission configuration states during the sidelink communications, receive, from the first UE, an indication of a first TCI state in accordance with the limitation, and communicate with the first UE in accordance with the first TCI state.

In some examples of the method, apparatuses, and non-transitory computer-readable medium described herein, the limitation defines that only one of the first UE or the second UE may be to transmit the potential TCI state.

Some examples of the method, apparatuses, and non-transitory computer-readable medium described herein may further include operations, features, means, or instructions for transmitting, to the second UE, an indication of assistance information associated with the sidelink communications between the first UE and the second UE.

In some examples of the method, apparatuses, and non-transitory computer-readable medium described herein, the limitation defines that all potential TCI states used during the sidelink communications may have a same time threshold for application of the potential TCI states.

Some examples of the method, apparatuses, and non-transitory computer-readable medium described herein may further include operations, features, means, or instructions for transmitting, to the second UE, an acknowledgement message associated with the indication from the second UE of first TCI state and applying the first TCI state to the sidelink communications with the second UE after transmission of the acknowledgement message and after the time threshold.

In some examples of the method, apparatuses, and non-transitory computer-readable medium described herein, the time threshold may be defined in the first control information as a quantity of symbols that follows receipt of an acknowledgement message responsive to transmission of the indication of the first TCI state.

Some examples of the method, apparatuses, and non-transitory computer-readable medium described herein may further include operations, features, means, or instructions for transmitting, to the second UE, a second indication of a second TCI state, receiving, from the second UE, a second acknowledgement message associated with the second indication from the first UE of the second TCI state, and communicating with the second UE in accordance with the second TCI state after transmission of the second acknowledgement message and after the time threshold.

In some examples of the method, apparatuses, and non-transitory computer-readable medium described herein, communicating with the first UE in accordance with the second TCI state may include operations, features, means, or instructions for switching from communicating in accordance with the first TCI state to communicating in accordance with the second TCI state.

In some examples of the method, apparatuses, and non-transitory computer-readable medium described herein, the first UE communicates according to a TDM communication scheme.

A method for wireless communications at a first UE is described. The method may include transmitting, to a second UE, first control information that indicates a first TCI state for use in sidelink communications between the first UE and the second UE, receiving, from the second UE, second control information that indicates a second TCI state for use in the sidelink communications between the first UE and the second UE, where a first application time of the first TCI state conflicts with a second application time of the second TCI state, selecting, in accordance with one or more rules for resolving sidelink TCI state conflicts, one of the first TCI state or the second TCI state as a selected TCI state, and communicating with the second UE in accordance with the selected TCI state.

An apparatus for wireless communications at a first UE is described. The apparatus may include a processor, memory coupled with the processor, and instructions stored in the memory. The instructions may be executable by the processor to cause the apparatus to transmit, to a second UE, first control information that indicates a first TCI state for use in sidelink communications between the first UE and the second UE, receive, from the second UE, second control information that indicates a second TCI state for use in the sidelink communications between the first UE and the second UE, where a first application time of the first TCI state conflicts with a second application time of the second TCI state, select, in accordance with one or more rules for resolving sidelink TCI state conflicts, one of the first TCI state or the second TCI state as a selected TCI state, and communicate with the second UE in accordance with the selected TCI state.

Another apparatus for wireless communications at a first UE is described. The apparatus may include means for transmitting, to a second UE, first control information that indicates a first TCI state for use in sidelink communications between the first UE and the second UE, means for receiving, from the second UE, second control information that indicates a second TCI state for use in the sidelink communications between the first UE and the second UE, where a first application time of the first TCI state conflicts with a second application time of the second TCI state, means for selecting, in accordance with one or more rules for resolving sidelink TCI state conflicts, one of the first TCI state or the second TCI state as a selected TCI state, and means for communicating with the second UE in accordance with the selected TCI state.

A non-transitory computer-readable medium storing code for wireless communications at a first UE is described. The code may include instructions executable by a processor to transmit, to a second UE, first control information that indicates a first TCI state for use in sidelink communications between the first UE and the second UE, receive, from the second UE, second control information that indicates a second TCI state for use in the sidelink communications between the first UE and the second UE, where a first application time of the first TCI state conflicts with a second application time of the second TCI state, select, in accordance with one or more rules for resolving sidelink TCI state conflicts, one of the first TCI state or the second TCI state as a selected TCI state, and communicate with the second UE in accordance with the selected TCI state.

In some examples of the method, apparatuses, and non-transitory computer-readable medium described herein, the one or more rules define that the selected TCI state may be selected, by the first UE, based on a comparison of a first priority associated with the first UE and a second priority associated with the second UE.

In some examples of the method, apparatuses, and non-transitory computer-readable medium described herein, selecting one of the first TCI state or the second TCI state as the selected TCI state may include operations, features, means, or instructions for comparing the first priority and the second priority and determining the selected TCI state from the first TCI state or the second TCI state that was transmitted by the first UE or the second UE, respectively, that corresponds with a highest priority between the first priority and the second priority.

In some examples of the method, apparatuses, and non-transitory computer-readable medium described herein, the first priority and the second priority may be based on a UE type of the first UE and the second UE, respectively.

In some examples of the method, apparatuses, and non-transitory computer-readable medium described herein, the UE type of the highest priority may be a hub UE, a RSU, or a PLC.

In some examples of the method, apparatuses, and non-transitory computer-readable medium described herein, the first priority and the second priority may be based on a quality of channel knowledge of the first UE and the second UE, respectively.

In some examples of the method, apparatuses, and non-transitory computer-readable medium described herein, the quality of channel knowledge may be based in part on at least one of an update frequency of a CSI-RS beam codebook or a degree of refinement of the CSI-RS beam codebook.

In some examples of the method, apparatuses, and non-transitory computer-readable medium described herein, the first priority and the second priority may be based on a TCI state command type of the first control information of the first UE and of the second control information of the second UE, respectively.

In some examples of the method, apparatuses, and non-transitory computer-readable medium described herein, the TCI state command type of the highest priority may be a TCI state command that includes a request to set a transmit beam.

In some examples of the method, apparatuses, and non-transitory computer-readable medium described herein, the first priority and the second priority may be based on a UE role of the first UE and the second UE, respectively, in the sidelink communications.

In some examples of the method, apparatuses, and non-transitory computer-readable medium described herein, the UE role of the highest priority may be a transmitter UE when the sidelink communications may be one-directional.

In some examples of the method, apparatuses, and non-transitory computer-readable medium described herein, the one or more rules define that the selected TCI state may be selected, by the first UE, based on a comparison of a first timing of a first acknowledgement message received in response to the first control information indicating the first TCI state and a second timing of a second acknowledgement message transmitted in response to the second control information indicating the second TCI state.

In some examples of the method, apparatuses, and non-transitory computer-readable medium described herein, selecting one of the first TCI state or the second TCI state as the selected TCI state may include operations, features, means, or instructions for comparing the first timing and the second timing and determining the selected TCI state from the first TCI state or the second TCI state that was transmitted by the first UE or the second UE, respectively, that corresponds with an earliest of the first timing and the second timing.

In some examples of the method, apparatuses, and non-transitory computer-readable medium described herein, selecting one of the first TCI state or the second TCI state as the selected TCI state may include operations, features, means, or instructions for comparing the first timing and the second timing and determining the selected TCI state from the first TCI state or the second TCI state that was transmitted by the first UE or the second UE, respectively, that corresponds with a latest of the first timing and the second timing.

### BRIEF DESCRIPTION OF THE DRAWINGS

FIG. 1 illustrates an example of a wireless communications system that supports sidelink transmission configuration indicator (TCI) state command conflict resolution in accordance with one or more aspects of the present disclosure.

FIG. 2 illustrates an example of a wireless communications system that supports sidelink TCI state command conflict resolution in accordance with one or more aspects of the present disclosure.

FIG. 3 illustrates an example of a timing diagram that supports sidelink TCI state command conflict resolution in accordance with one or more aspects of the present disclosure.

FIG. 4 illustrates an example of a process flow that supports sidelink TCI state command conflict resolution in accordance with one or more aspects of the present disclosure.

FIG. 5 illustrates an example of a process flow that supports sidelink TCI state command conflict resolution in accordance with one or more aspects of the present disclosure.

FIGS. 6 and 7 illustrate block diagrams of devices that support sidelink TCI state command conflict resolution in accordance with one or more aspects of the present disclosure.

FIG. 8 illustrates a block diagram of a communications manager that supports sidelink TCI state command conflict resolution in accordance with one or more aspects of the present disclosure.

FIG. 9 illustrates a diagram of a system including a device that supports sidelink TCI state command conflict resolution in accordance with one or more aspects of the present disclosure.

FIGS. 10 through 12 illustrate flowcharts showing methods that support sidelink TCI state command conflict resolution in accordance with one or more aspects of the present disclosure.

### DETAILED DESCRIPTION

Some wireless communication systems may support sidelink communications in which two or more wireless devices, such as a first user equipment (UE) and a second UE, communicate using one or more beam pairs, where each beam pair includes a transmit beam and a receive beam. In some cases, the first UE may select a first beam, such as a receive beam, for communicating with the second UE and may transmit, to the second UE, an indication of a transmission configuration indicator (TCI) state, which may be referred to as a TCI state command, associated with a second beam, such as a transmit beam, where the first beam and the second beam are part of a beam pair. In some examples, the first UE may transmit, to the second UE, a first TCI state command indicating a first TCI state and the second UE may transmit, to the first UE, a second TCI state command indicating a second TCI state, such that an application time of the first TCI state and an application time of the second TCI state may coincide. That is, the first UE may transmit an indication of the first TCI state associated with a receive beam and the second UE may transmit an indication of the second TCI associated with a transmit beam, such that the first UE may apply the second TCI state and the second UE may apply the first TCI state simultaneously. However, in some cases, the first TCI state and the second TCI state may be incompatible (e.g., not part of a beam pair). In such cases, the UEs may be unable to communicate via the indicated TCI states.

Accordingly, techniques described herein may support methods for preventing or resolving TCI state command conflicts associated with coinciding application times. In some examples, a first UE and a second UE may receive control information indicating a limitation to transmission of TCI state commands (e.g., a potential TCI state). For example, the limitation may define that only one of the first UE or the second UE may transmit TCI state commands. In such cases, the other UE (e.g., UE restricted from transmitting TCI state commands) may transmit assistance information to aid in selection of a TCI state to be indicated via a TCI state command. In some other examples, both the first UE and the second UE may each transmit TCI state commands and the limitation may define that all TCI state commands are associated with a same time threshold for application of the TCI state commands. In such cases, application times of the TCI state commands may be unique (e.g., not coincide) due to time division multiplexing (TDM).

Additionally, or alternatively, the first UE and the second UE may receive control information indicating (e.g., may be configured with) one or more rules associated with resolving TCI state command conflicts. For example, the one or more rules may define that the UEs select a TCI state command from a set of conflicting TCI state commands based on a comparison of a priorities associated with each UE, such that the selected TCI state command is associated with a highest priority. Additionally, or alternatively, the one or more rules many define that the UEs select the TCI state command from the set of conflicting TCI state commands based on a comparison of timing associated with acknowledgement messages associated with each TCI state command. For example, each TCI state command from the set of conflicting TCI state commands may be associated with an acknowledgement message, such that the selected TCI state command is associated with an earliest received acknowledgement message. Conversely, the selected TCI state command may be associated with a latest received acknowledgement message.

Aspects of the disclosure are initially described in the context of wireless communications systems. Aspects of the disclosure are then described in the context of a timing diagram and process flows. Aspects of the disclosure are further illustrated by and described with reference to apparatus diagrams, system diagrams, and flowcharts that relate to sidelink TCI state command conflict resolution.

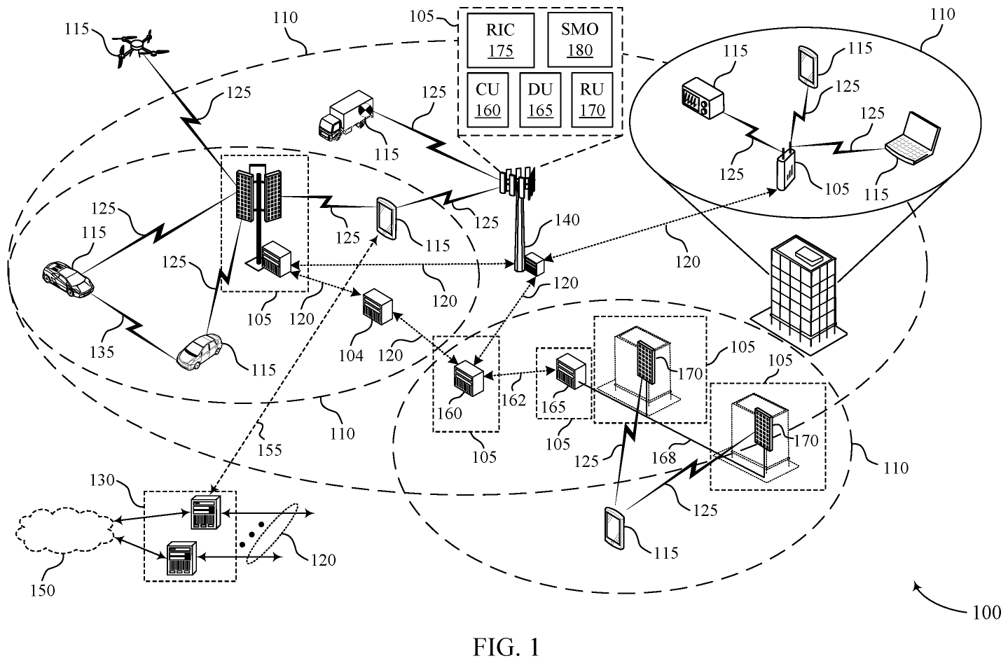

FIG. 1 illustrates an example of a wireless communications system 100 that supports sidelink TCI state command conflict resolution in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink transmission configuration indicator TCI state command conflict resolution as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may support techniques to avoid or resolve TCI state command confliction in sidelink communications. For example, a first UE 115 may be in sidelink communications with a second UE 115 and each UE 115 may receive control information that indicates a limitation to transmission of a potential TCI state, where the limitation restricts the first UE 115 and the second UE 115 from simultaneously applying different potential TCI states during the sidelink communications. In some examples, the limitation may define that only the first UE 115 or the second UE 115 is allowed to transmit the potential TCI state. Additionally, or alternatively, the limitation may define that all potential TCI states used during the sidelink communications have a same time threshold for application of the potential TCI states.

Additionally, or alternatively, the first UE 115 may transmit, to the second UE 115, first control information that indicates a first TCI state and may receive, from the second UE 115, second control information that indicates a second TCI state. Accordingly, the first UE 115 and the second UE 115 may select one of the first TCI state or the second TCI state as a selected TCI state based on one or more rules for resolving sidelink TCI state conflicts. In some examples, the one or more rules may define that the selected TCI state is selected based on a comparison of a first priority associated with the first UE 115 and a second priority associated with the second UE 115. Additionally, or alternatively, the one or more rules may define that the selected TCI state is selected based on a comparison of first timing of a first acknowledgement message received in response to the first control information and second timing of a second acknowledgement message transmitted in response to the second control information. As such, the first UE 115 and the second UE 115 may communicate in accordance with the selected TCI state.

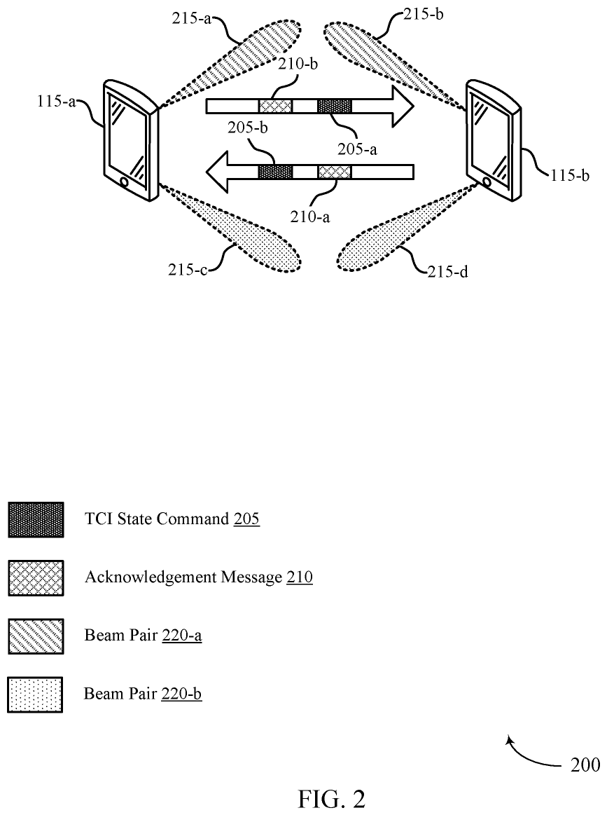

FIG. 2 illustrates an example of a wireless communications system 200 that supports sidelink TCI state command conflict resolution in accordance with one or more aspects of the present disclosure. In some examples, the wireless communications system 200 may implement or be implemented by aspects of the wireless communications system 100. For example, the wireless communications system 200 may include one or more network entities 105 and one or more UEs 115 (e.g., a UE 115-a and a UE 115-b), which may be examples of the corresponding devices as described with reference to FIG. 1. The wireless communications system 200 may include features for preventing or resolving TCI state command (e.g., TCI command) confliction as described herein.

Some wireless communication systems may support sidelink communications in which two or more wireless devices, such as a UE 115-a and a UE 115-b, may communicate via one or more sidelink communications links. For example, the UE 115-a and the UE 115-b may communicate using one or more beam pairs 220, such as a beam pair 220-a and a beam pair 220-b, where each beam pair 220 includes a transmit beam 215 and a receive beam 215. In some cases, the UE 115-a may select a beam 215, such as a beam 215-a (e.g., a receive beam 215-a), for communicating with the UE 115-b and may transmit, to the UE 115-b, an indication of a TCI state, which may be referred to as a TCI state command 205 (e.g., TCI command 205), associated with a beam 215-b (e.g., a transmit beam 215-b), where the beam 215-a and the beam 215-b are part of the beam pair 220-a.

Some TCI state commands 205 (e.g., shared separate TCI state commands 205) may be applicable to either sidelink communication links (e.g., channels) used for transmitting (e.g., forward link (FL) channels) or sidelink communication links used for receiving (e.g., reverse link (RL) channels). That is, the UE 115-a may transmit sidelink communications to the UE 115-b via a first channel (e.g., a FL physical sidelink shared channel (PSSCH), a FL physical sidelink control channel (PSCCH), or a FL physical sidelink feedback channel (PSFCH)) and receive sidelink communications from the UE 115-b via a second channel (e.g., a RL PSSCH, FL PSCCH, FL PSFCH), such that a TCI state command 205 may indicate a TCI state (e.g., shared separate FL TCI state) that may be applied to the first channel or may indicate a TCI state (e.g., shared separate RL TCI state) to be applied the second channel. Some other TCI state commands 205 (e.g., shared joint TCI state commands 205) may be applicable to multiple channels, such as both the first channel and the second channel. That is, the UE 115-a may transmit sidelink communications to the UE 115-b via the first channel and receive sidelink communications from the UE 115-b via the second channel, such that a TCI state command 205 may indicate a TCI state that may be applied to both the first channel and the second channel. The UE 115-a, the UE 115-b, or both, may transmit TCI state commands 205 via sidelink control information (SCI) or via sidelink medium access control (MAC) control element (MAC-CE).

In some examples, the UE 115-a may select the beam 215-a (e.g., the receive beam 215-a) for communicating with the UE 115-b and may transmit a TCI state command 205-a indicating a TCI state associated with the beam 215-b (e.g., the transmit beam 215-b) for the UE 115-b to use to communicate with the UE 115-a. Additionally, the UE 115-b may select a beam 215-d (e.g., a transmit beam) for communicating with the UE 115-a and may transmit a TCI state command 205-b indicating a TCI state associated with a beam 215-c (e.g., a receive beam 215-c) for the UE 115-a to use to communicate with the UE 115-b. In such cases, the UE 115-a may transmit the TCI state command 205-a and the UE 115-b may transmit the TCI state command 205-b within a duration, such that an application time of the TCI state command 205-a and an application time of the TCI state command 205-b may coincide (e.g., may be simultaneous, may overlap in the time domain. That is, the UE 115-b may transmit an acknowledgement message 210-a in response to the TCI state command 205-a and may apply the TCI state indicated via the TCI state command 205-a (e.g., apply the TCI state command 205-a) based on transmitting the acknowledgement message 210-a. Similarly, the UE 115-a may transmit an acknowledgement message 210-b in response to the TCI state command 205-b and may apply the TCI state indicated via the TCI state command 205-b (e.g., apply the TCI state command 205-b) based on transmitting the acknowledgement message 210-b. In such cases, a time at which the UE 115-a applies the TCI state command 205-b (e.g., the application time of the TCI state command 205-b) may coincide (e.g., be simultaneous) with a time that the UE 115-b applies the TCI state command 205-a (e.g., the application time of the TCI state command 205-a).

In some examples (e.g., if a TCI state command 205 is transmitted via MAC-CE), the UE 115-a, the UE 115-b, or both, may apply a TCI state command 205 a configured (e.g., preconfigured) threshold of time (e.g., 3 ms) after an acknowledgement message 210 associated with the TCI state command 205 is received. In some other examples (e.g., if a TCI state command 205 is transmitted via SCI), the UE 115-a, the UE 115-b, or both, may apply a TCI state command 205 a configured (e.g., preconfigured) quantity (e.g., number) of symbols (e.g., Y symbols) after an acknowledgement message 210 associated with the TCI state command 205 is received.

However, in some cases, the beam 215-b (e.g., transmit beam 215-b) associated with (e.g., indicated via) the TCI state command 205-a and the beam 215-c (e.g., receive beam 215-c) associated with the TCI state command 205-b may be incompatible (e.g., not part of a beam pair 220). That is, the beam 215-b may be part of the beam pair 220-a and the beam 215-c may be part of the beam pair 220-b. In other words, the TCI state command 205-a and the TCI state command 205-b may be conflicting TCI state commands 205. In such cases, the UE 115-a and the UE 115-b may be unable to communicate via the TCI states (e.g., beams 215) indicated via the conflicting TCI state commands 205 (e.g., due to the coinciding application times).

Accordingly, techniques described herein may support avoiding (e.g., preventing) or resolving transmission of conflicting TCI state commands 205 (e.g., with coinciding application times). In some implementations, a first UE, such as a UE 115-a, and a second UE, such as a UE 115-b, may receive (e.g., from a network entity 105, another UE 115, etc.) control information indicating a limitation that restricts the UE 115-a and the UE 115-b from simultaneously applying different potential TCI states associated with conflicting TCI state commands 205 during sidelink communications.

In some cases, the limitation may define that only one of the UE 115-a or the UE 115-b is to transmit (e.g., is allowed to transmit) TCI state commands 205 (e.g., indications of potential TCI states). For example, the UE 115-a may receive the control information indicating that the UE 115-a may transmit TCI state commands 205, such that the UE 115-a may transmit a TCI state command 205-a to the UE 115-b. Additionally, or alternatively, the UE 115-b may receive the control information indicating that the UE 115-b is restricted from transmitting TCI state commands 205, such that the UE 115-b may refrain from transmitting a TCI state command 205-b. In such cases, the UE 115-b may transmit assistance information, reports, or both, to the UE 115-a to support the UE 115-a determining the TCI state command 205-a. That is, the assistance information, reports, or both, may indicate information associated with communications of the UE 115-b, such as channel quality, beam reports, interference, or the like thereof, such that the UE 115-a may select a beam pair 220, such as a beam pair 220-a, for communicating with the UE 115-b. Accordingly, the UE 115-a may transmit the TCI state command 205-a indicating the beam 215-b (e.g., indicating the TCI state associated with the beam 215-b), such that the UE 115-a and the UE 115-b may communicate via the beam pair 220-a. In some cases, the UE 115 configured to (e.g., enabled to, permitted to, allowed to) transmit TCI state commands 205 may be, for example, a roadside unit (RSU) (e.g., for vehicle-to-everything (V2X) purposes) or a programmable logic controller (PLC) (e.g., for industrial internet of things (IIoT). purposes).

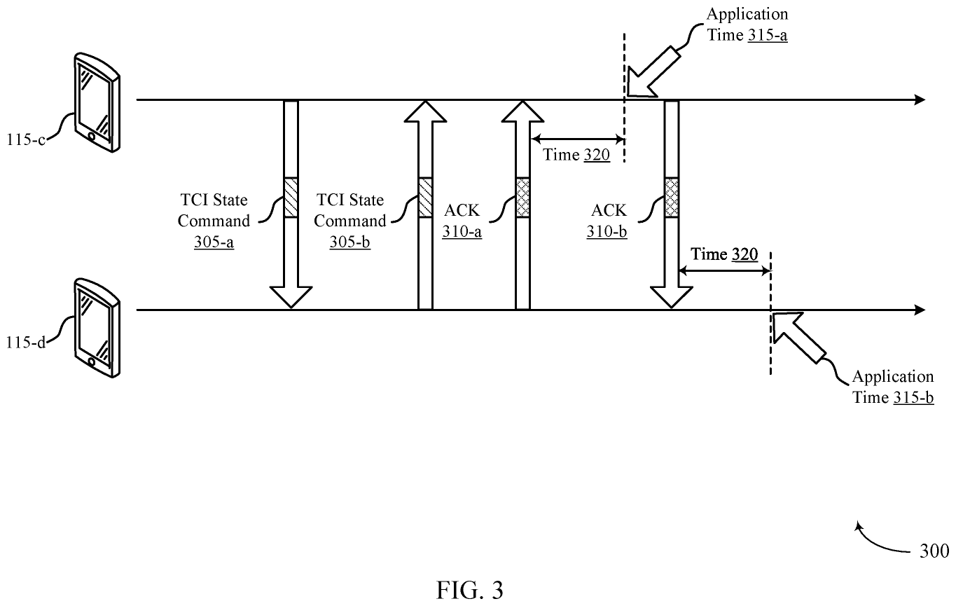

Additionally, or alternatively, the limitation may define that all TCI state commands 205 may be associated with a same time threshold for application of the TCI state commands 205. In other words, all potential TCI states indicated via TCI state commands 205 may have a same time threshold for application of the potential TCI states. For example, the time threshold (e.g., indicated via the control information) may be a quantity of symbols (e.g., Y symbols) that follows receipt of an acknowledgement message responsive to transmission of a TCI state command 205. As such, the UE 115-a and the UE 115-b may transmit (e.g., at different times) the TCI state command 205-a and the TCI state command 205-b, respectively, and may apply the TCI state commands 205 (e.g., at different times) based on receiving the acknowledgement message 210-a and the acknowledgement message 210-b, respectively. Thus, the UEs 115 may apply the TCI state commands 205 at different times (e.g., due to the TDM nature), avoiding conflict between the TCI state commands 205, described with reference to FIG. 3.

Additionally, or alternatively, the UEs 115-a and 115-b may receive (e.g., from a network entity 105, another UE 115, etc.) an indication of a one or more rules for resolving conflicting TCI state commands 205, such as the TCI state command 205-a and the TCI state command 205-b. For example, the UE 115-a may transmit the TCI state command 205-a indicating the beam 215-b (e.g., indicating a TCI state associated with the beam 215-b) and the UE 115-b may transmit the TCI state command 205-b indicating the beam 215-c (e.g., indicating a TCI state associated with the beam 215-c), such that the application time of the TCI state command 205-a coincides with the application time of the TCI state command 205-b, resulting the TCI state command 205-a conflicting with the TCI state command 205-b. Accordingly, the UE 115-a, the UE 115-b, or both, may select one of the TCI state command 205-a (e.g., the TCI state indicated via the TCI state command 205-a) or the TCI state command 205-b (e.g., the TCI state indicated via the TCI state command 205-b) based on the one or more rules for resolving conflicting TCI state commands 205. As such, the UE 115-a, the UE 15-b, or both, may apply the selected TCI state command 205 and communicate in accordance with the selected TCI state (e.g., associated with the selected TCI state command 205)

In some examples, a first rule of the one or more rules may define that the selected TCI state is selected (e.g., by the UE 115-a, the UE 115-b, or both) based on a comparison of a first priority associated with the UE 115-a and a second priority associated with the UE 115-b. That is, the UE 115-a, the UE 115-b, or both, may compare the first priority and the second priority and may determine the selected TCI state command 205 from the TCI state command 205-a or the TCI state command 205-b based on the UE 115 associated with a highest priority between the first priority or the second priority. For example, the first priority may be higher than the second priority, such that the UEs 115 select (e.g., and apply) the TCI state command 205-a, such that the UEs 115 may communicate via the beam pair 220-a (e.g., the beam 215-a and the beam 215-b).

In some cases (e.g., start topology), the first priority and the second priority may be based on a UE 115 type of the UE 115-a and the UE 115-b, respectively. In such cases, the UE 115 type of the highest priority may be a hub UE 115, (e.g., hub sidelink UE 115), a RSU (e.g., in V2X), or a PLC (e.g., in IIoT). Additionally, or alternatively, the first priority and the second priority are based on a quality of channel knowledge of the UE 115-a and the UE 115-b, respectively. In such cases, the UE 115 associated with the highest priority may be associated with the highest quality of channel knowledge. That is, the quality of channel knowledge may be based on at least one of an update frequency of a channel state information reference signal (CSI-RS) beam codebook or a degree of refinement of the CSI-RS beam codebook, such that the UE 115 associated with the highest priority may receive a more frequent or refined CSI-RS beam codebook. Additionally, or alternatively, the first priority and the second priority may be based on a TCI state command 205 type of the TCI state command 205-a and the TCI state command 205-b, respectively. In such cases, the TCI state command type of the highest priority may be a TCI state command 205 that includes a request to set a transmit beam 215 (e.g., compared to a TCI state command 205 that includes a request to set a receive beam 215). Additionally, or alternatively, the first priority and the second priority may be based on a UE 115 role of the UE 115-a and the UE 115-b, respectively. In such cases, the UE 115 role of the highest priority may be a transmitter UE 115 (e.g., when the sidelink communications are one-directional).

Additionally, or alternatively, a second rule of the one or more rules may define that the selected TCI state is selected (e.g., by the UE 115-a, the UE 115-b, or both) based on a comparison of timing associated with reception of acknowledgement messages 210 associated with the TCI state commands 205. That is, the UE 115-a, the UE 115-b, or both, may compare first timing associated with the acknowledgement message 210-a received in response to the TCI state command 205-a and second timing associated with the acknowledgement message 210-b received in response to the TCI state command 205-b. In some examples, the second rule may indicate to select the TCI state command 205 associated with an earliest received acknowledgement message 210. For example, the UE 115-b may apply the TCI state command 205-a based on the UE 115-a receiving the acknowledgement message 210-a associated with the TCI state command 205-a before the UE 115-b receives the acknowledgement message 210-b associated with the TCI state command 205-b (e.g., based on the first timing being before the second timing). In some other examples, the second rule may indicate to select the TCI state command 205 associated with a latest (e.g., last) received acknowledgement message 210. For example, the UE 115-a may apply the TCI state command 205-b based on the UE 115-b receiving the acknowledgement message 210-b associated with the TCI state command 205-b after the UE 115-a receives the acknowledgement message 210-a associated with the TCI state command 205-b (e.g., based on the second timing being after the first timing).

In other words, the second rule of the one or more rules may indicate for the UE 115-a and the UE 115-b to apply a TCI state command 205 based on the order of slots during which the acknowledgement message 210-a and the acknowledgement message 210-b are communicated. For example, the second rule of the one or more rules may indicate for the UE 115-a and the UE 115-b to select the TCI state associated with the TCI state command 205-a based on the UE 115-a receiving an acknowledgement message 210-a associated with the TCI state command 205-a during a first slot which occurs before a second slot during which the UE 115-b receives an acknowledgement message 210-b associated with the TCI state command 205-b. Conversely, the second rule of the one or more rules may indicate for the UE 115-a and the UE 115-b to select the TCI state associated with the TCI state command 205-b based on the UE 115-b receiving the acknowledgement message 210-b associated with the TCI state command 205-b during the second slot which occurs after the first slot during which the UE 115-a receives the acknowledgement message 210-a associated with the TCI state command 205-a.

FIG. 3 illustrates an example of a timing diagram 300 that supports sidelink TCI state command conflict resolution in accordance with one or more aspects of the present disclosure. In some examples, the timing diagram 300 may implement or be implemented by aspects of the wireless communications system 100 or the wireless communications system 200. For example, the timing diagram 300 may include one or more network entities 105 and one or more UEs 115 (e.g., a UE 115-c and a UE 115-d), which may be examples of the corresponding devices as described with reference to FIG. 1. The timing diagram 300 may include features for preventing or resolving TCI state command confliction as described herein.

In some examples, a UE 115-c and a UE 115-d may transmit a TCI state command 305-a and a TCI state command 305-b respectively. In some examples, the TCI state command 305-a may indicate for the UE 115-d to communicate via a receive beam (e.g., associated with a first TCI state) and the TCI state command 305-b may indicate for the UE 115-c to communicate via a transmit beam (e.g., associated with a second TCI state). In some cases, the receive beam and the transmit beam may be incompatible (e.g., not part of a beam pair) and an application time 315 associated with the receive beam may coincide with an application time associated with the transmit beam. In other words, the TCI state command 305-a and the TCI state command 305-b may be conflicting TCI state commands 305 (e.g., the first TCI state and the second TCI state may conflict).

According, as described with reference to FIG. 2, the UE 115-c and the UE 115-d may receive control information indicating a limitation that restricts the UE 115-c and the UE 115-d from simultaneously applying different TCI state commands 305 (e.g., potential TCI states) during the sidelink communications. Additionally, the limitation may define that all TCI state commands 305 (e.g., all potential TCI states) used during sidelink communications may have a same time threshold for application of the TCI state commands 305. In such cases, the time threshold may be a quantity of symbols (e.g., preconfigure quantity of symbols) after receipt of an acknowledgement message 310 (e.g., ACK 310) in response to a TCI state command 305. In some examples, the UEs 115 may receive the indication of the limitation (e.g., an indication of the time threshold) via an RRC message.

For example, the UE 115-c may transmit, to the UE 115-d, the TCI state command 305-a at a first time and the UE 115-d may transmit, to the UE 115-c, the TCI state command 305-b at a second time, where the TCI state command 305-a and the TCI state command 305-b conflict (e.g., indicate beams that are not part of a beam pair). Additionally, the UE 115-c may receive, from the UE 115-d, an acknowledgement message 310-a (e.g., ACK 310-a) in response to the TCI state command 305-a (e.g., at a third time). As such, the UEs 115 may apply the TCI state command 305-a (e.g., may begin communicating via the TCI state indicated via the TCI state command 305-a) at an application time 315-a, which may be a time 320 (e.g., the quantity of symbols) after the UE 115-c receives the acknowledgement message 310-a, where the time 320 is based on the time threshold indicated via the limitation. Additionally, the UE 115-d may receive, from the UE 115-c, an acknowledgement message 310-b (e.g., ACK 310-b) in response to the TCI state command 305-b (e.g., at a fourth time). As such, the UEs 115 may apply the TCI state command 305-b (e.g., may begin communicating via the TCI state indicated via the TCI state command 305-b) at an application time 315-b, which may be the time 320 after the UE 115-d receives the acknowledgement message 310-b. In other words, the UE 115-c and the UE 115-d may communicate via a beam pair (e.g., TCI state) associated with the TCI state command 305-a from the application time 315-a until the application time 315-b and may switch to communicating via a beam pair associated with the TCI state command 305-b the time 320 after the UE 115-d receives the acknowledgement message 310-b (e.g., at the application time 315-b). In other words, the UE 115-c and the UE 115-d may communicate according to a TDM communication scheme, such that the first time, the second time, the third time, and the fourth time may all be different (e.g., which may prevent coinciding application times 315).

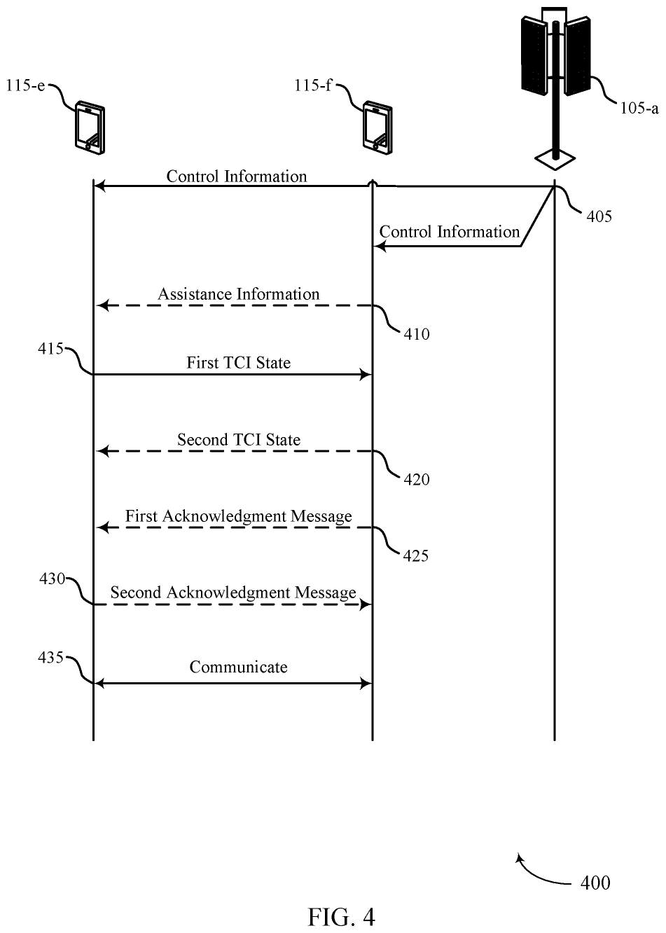

FIG. 4 illustrates an example of a process flow 400 that supports sidelink TCI state command conflict resolution in accordance with one or more aspects of the present disclosure. In some examples, the process flow 400 may implement or be implemented by aspects of the wireless communications system 100, the wireless communications system 200, and the timing diagram 300. For example, the process flow 400 may include one or more network entities 105 (e.g., a network entity 105-a) and one or more UEs 115 (e.g., a UE 115-e and a UE 115-f), which may be examples of the corresponding devices as described with reference to FIG. 1. The process flow 400 may include features for preventing TCI state command confliction as described herein.

At 405, the UE 115-e, the UE 115-f, or both, may receive (e.g., from the network entity 105-a, the UE 115-e, the UE 115-f, or another UE 115) first control information that is indicative of a limitation to transmission, by a sidelink UE 115, of a potential TCI state. The limitation may restrict the UE 115-e and the UE 115-f (e.g., in sidelink communications with the UE 115-e) from simultaneously applying different potential TCI states during the sidelink communications.

In some cases, the limitation may define that only one of the UE 115-e or the UE 115-f is to transmit the potential TCI state. In some examples, the limitation may define that only one of the UE 115-e or the UE 115-f is to transmit the potential TCI state based on a designated UE 115 type of the UE 115-e or the UE 115-f. That is, the designated UE 115 type may be representative of UEs 115 allowed to transmit the potential TCI state in accordance with the limitation. In some cases, the designated UE 115 type may be an RSU or a PLC.

Additionally, or alternatively, the limitation may define that all potential TCI states used during the sidelink communications have a same time threshold for application of the potential TCI states. In some cases, the time threshold may define a quantity of symbols that follows receipt of an acknowledgement message responsive to transmission of an indication of a TCI state.

In some cases, at 410, the UE 115-e may receive, from the UE 115-f, an indication of assistance information associated with the sidelink communications between the UE 115-e and the UE 115-f (e.g., based on the limitation may defining that only the UE 115-e is to transmit the potential TCI state).

At 415, the UE 115-e may transmit, to the UE 115-f, an indication of a first TCI state in accordance with the limitation. For example, the limitation may define that only the UE 115-e is to transmit the potential TCI state. That is, the UE 115-f may determine that a type of the UE 115-e matches a designated UE 115 type specified by the limitation. In some examples, the UE 115-e may determine the first TCI state based on the assistance information.

In some cases, at 420, the UE 115-e may receive, from the UE 115-f, an indication of a second TCI state in accordance with the limitation. For example, the limitation may define that only the UE 115-f is to transmit the potential TCI state.

In some cases, at 425, the UE 115-e may receive, from the UE 115-f, a first acknowledgement message in response to (e.g., associated with) the indication of the first TCI state (e.g., from the UE 115-e).

In some cases, at 430, the UE 115-e may transmit, to the UE 115-f, a second acknowledgement message in response to the indication of the second TCI state (e.g., from the UE 115-f).

Accordingly, at 435, the UE 115-e and the UE 115-f may communicate in accordance with the first TCI state or the second TCI state (e.g., based on the limitation). For example, the UE 115-e and the UE 115-f may communicate in accordance with the first TCI state. Additionally, or alternatively, the UE 115-e and the UE 115-f may communicate in accordance with the second TCI state. In such cases, the UEs 115 may communicate according to a TDM communication scheme.

For example, the UEs 115 may apply the first TCI state to the sidelink communications after receipt of the first acknowledgement message and after the time threshold (e.g., the time threshold after receipt of the first acknowledgement message). Additionally, or alternatively, the UEs 115 may apply the second TCI state to the sidelink communications after receipt of the second acknowledgement message and after the time threshold (e.g., the time threshold after receipt of the second acknowledgement message). For example, the UEs 115 may switch from communicating in accordance with the first TCI state to communicating in accordance with the second TCI state.

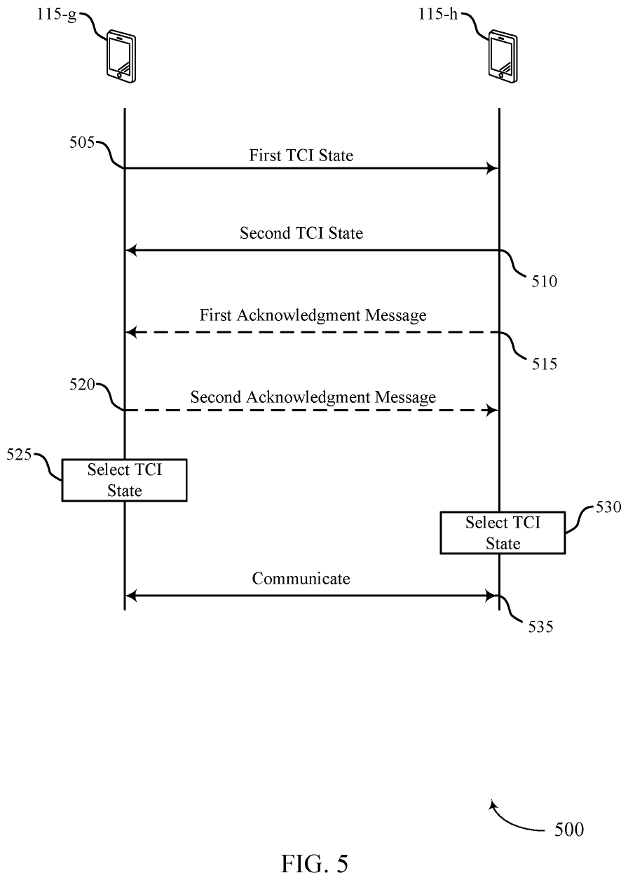

FIG. 5 illustrates an example of a process flow 500 that supports sidelink TCI state command conflict resolution in accordance with one or more aspects of the present disclosure. In some examples, the process flow 500 may implement or be implemented by aspects of the wireless communications system 100, the wireless communications system 200, the timing diagram 300, and the process flow 400. For example, the process flow 500 may include one or more network entities 105 and one or more UEs 115 (e.g., a UE 115-g and a UE 115-h), which may be examples of the corresponding devices as described with reference to FIG. 1. The process flow 500 may include features for resolving TCI state command confliction as described herein.

At 505, the UE 115-g may transmit, to the UE 115-h, first control information (e.g., a first TCI state command) that indicates a first TCI state for use in sidelink communications between the UE 115-g and the UE 115-h.

At 510, the UE 115-g may receive, from the UE 115-h, second control information (e.g., a second TCI state command) that indicates a second TCI state for use in sidelink communications between the UE 115-g and the UE 115-h. Additionally, a first application time of the first TCI state may conflict (e.g., coincide) with a second application time of the second TCI state.

In some cases, at 515, the UE 115-g may receive, from the UE 115-g, a first acknowledgement message in response to the first control information indicating the first TCI state.

In some cases, at 520, the UE 115-g may transmit, to the UE 115-g, a second acknowledgement message in response to the second control information indicating the second TCI state.

At 525 and 530, each UE 115 (e.g., the UE 115-g, the UE 115-h, or both) may select one of the first TCI state or the second TCI state as a selected TCI state based on (e.g., in accordance with) one or more rules for resolving TCI state (e.g., sidelink TCI state) conflicts.

In some cases, the one or more rules may define that the selected TCI state is selected (e.g., by the UE 115-g, the UE 115-h, or both) based on a comparison of a first priority associated with the UE 115-g and a second priority associated with the UE 115-h. For example, each UE 115 (e.g., the UE 115-g, the UE 115-h, or both) may compare the first priority and the second priority and may determine the selected TCI state from the first TCI state or the second TCI state that corresponds with a highest priority between the first priority and the second priority.

In some cases, the first priority and the second priority may be based on a UE 115 type of the UE 115-g and the UE 115-h, respectively. For example, the UE 115 type of the highest priority may be a hub UE 115, an RSU, or a PLC. Additionally, or alternatively, the first priority and the second priority may be based on a quality of channel knowledge of the UE 115-g and the UE 115-h, respectively. For example, the UE 115 with a higher quality of channel knowledge may be associated with a higher priority. In some examples, the quality of channel knowledge may be based on at least one of an update frequency of a CSI-RS beam codebook or a degree of refinement of the CSI-RS beam codebook. Additionally, or alternatively, the first priority and the second priority may be based on a TCI state command type of the first control information of the UE 115-g and of the second control information of the UE 115-h, respectively. For example, the TCI state command type of the highest priority may be a TCI state command that includes a request to set a transmit beam. Additionally, or alternatively, the first priority and the second priority may be based on a UE 115 role of the UE 115-g and the UE 115-h, respectively, in the sidelink communications. For example, the UE 115 role of the highest priority may be a transmitter UE 115 when the sidelink communications are one-directional

Additionally, or alternatively, the one or more rules may define that the selected TCI state is selected (e.g., by the UE 115-g, the UE 115-h, or both) based on a comparison of a first timing of the first acknowledgement message received in response to the first control information indicating the first TCI state and a second timing of the second acknowledgement message transmitted in response to the second control information indicating the second TCI state. For example, each UE 115 (e.g., the UE 115-g, the UE 115-h, or both) may compare the first timing and the second timing and may determine the selected TCI state from the first TCI state or the second TCI state that corresponds with an earliest of the first timing and the second timing. Alternatively, each UE 115 (e.g., the UE 115-g, the UE 115-h, or both) may compare the first timing and the second timing and may determine the selected TCI state from the first TCI state or the second TCI state that corresponds with a latest of the first timing and the second timing

Accordingly, at 535, the UE 115-g and the UE 115-h may communicate in accordance with the selected TCI state.

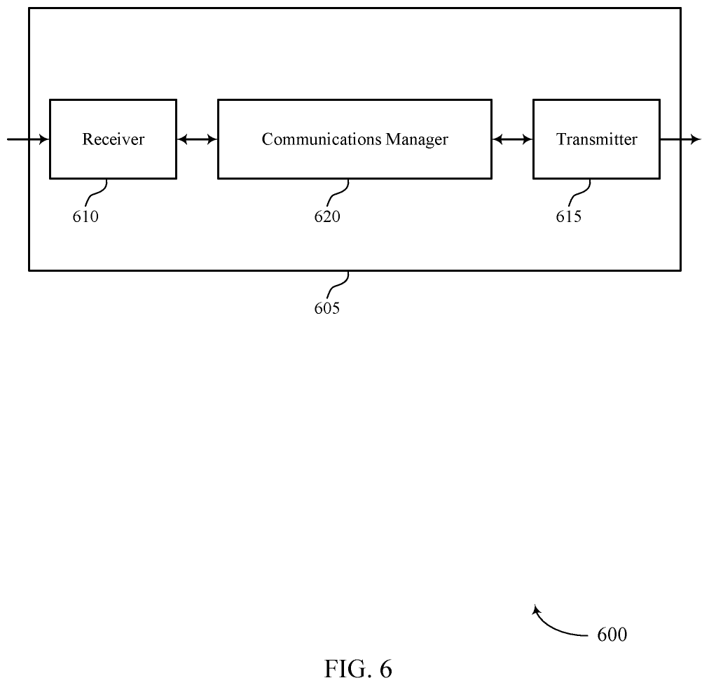

FIG. 6 illustrates a block diagram 600 of a device 605 that supports sidelink TCI state command conflict resolution in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink TCI state command conflict resolution). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink TCI state command conflict resolution). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of sidelink TCI state command conflict resolution as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE in accordance with examples as disclosed herein. For example, the communications manager 620 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The communications manager 620 may be configured as or otherwise support a means for transmitting, to the second UE, an indication of a first TCI state in accordance with the limitation. The communications manager 620 may be configured as or otherwise support a means for communicating with the second UE in accordance with the first TCI state.

Additionally, or alternatively, the communications manager 620 may support wireless communications at a first UE in accordance with examples as disclosed herein. For example, the communications manager 620 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The communications manager 620 may be configured as or otherwise support a means for receiving, from the first UE, an indication of a first TCI state in accordance with the limitation. The communications manager 620 may be configured as or otherwise support a means for communicating with the first UE in accordance with the first TCI state.

Additionally, or alternatively, the communications manager 620 may support wireless communications at a first UE in accordance with examples as disclosed herein. For example, the communications manager 620 may be configured as or otherwise support a means for transmitting, to a second UE, first control information that indicates a first TCI state for use in sidelink communications between the first UE and the second UE. The communications manager 620 may be configured as or otherwise support a means for receiving, from the second UE, second control information that indicates a second TCI state for use in the sidelink communications between the first UE and the second UE, where a first application time of the first TCI state conflicts with a second application time of the second TCI state. The communications manager 620 may be configured as or otherwise support a means for selecting, in accordance with one or more rules for resolving sidelink TCI state conflicts, one of the first TCI state or the second TCI state as a selected TCI state. The communications manager 620 may be configured as or otherwise support a means for communicating with the second UE in accordance with the selected TCI state.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for TCI state command conflict resolution in sidelink communications which may result in reduced processing, reduced power consumption, and more efficient utilization of communication resources, among other advantages.

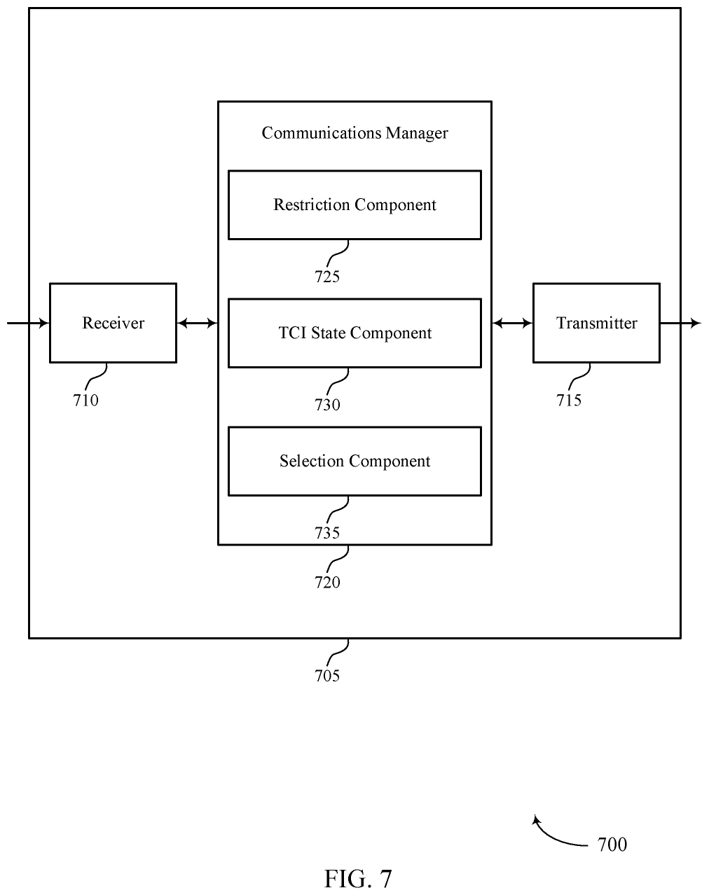

FIG. 7 illustrates a block diagram 700 of a device 705 that supports sidelink TCI state command conflict resolution in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to sidelink TCI state command conflict resolution). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to sidelink TCI state command conflict resolution). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of sidelink TCI state command conflict resolution as described herein. For example, the communications manager 720 may include a restriction component 725, a TCI state component 730, a selection component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. The restriction component 725 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The TCI state component 730 may be configured as or otherwise support a means for transmitting, to the second UE, an indication of a first TCI state in accordance with the limitation. The TCI state component 730 may be configured as or otherwise support a means for communicating with the second UE in accordance with the first TCI state.

Additionally, or alternatively, the communications manager 720 may support wireless communications at a first UE in accordance with examples as disclosed herein. The restriction component 725 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The TCI state component 730 may be configured as or otherwise support a means for receiving, from the first UE, an indication of a first TCI state in accordance with the limitation. The TCI state component 730 may be configured as or otherwise support a means for communicating with the first UE in accordance with the first TCI state.

Additionally, or alternatively, the communications manager 720 may support wireless communications at a first UE in accordance with examples as disclosed herein. The TCI state component 730 may be configured as or otherwise support a means for transmitting, to a second UE, first control information that indicates a first TCI state for use in sidelink communications between the first UE and the second UE. The TCI state component 730 may be configured as or otherwise support a means for receiving, from the second UE, second control information that indicates a second TCI state for use in the sidelink communications between the first UE and the second UE, where a first application time of the first TCI state conflicts with a second application time of the second TCI state. The selection component 735 may be configured as or otherwise support a means for selecting, in accordance with one or more rules for resolving sidelink TCI state conflicts, one of the first TCI state or the second TCI state as a selected TCI state. The TCI state component 730 may be configured as or otherwise support a means for communicating with the second UE in accordance with the selected TCI state.

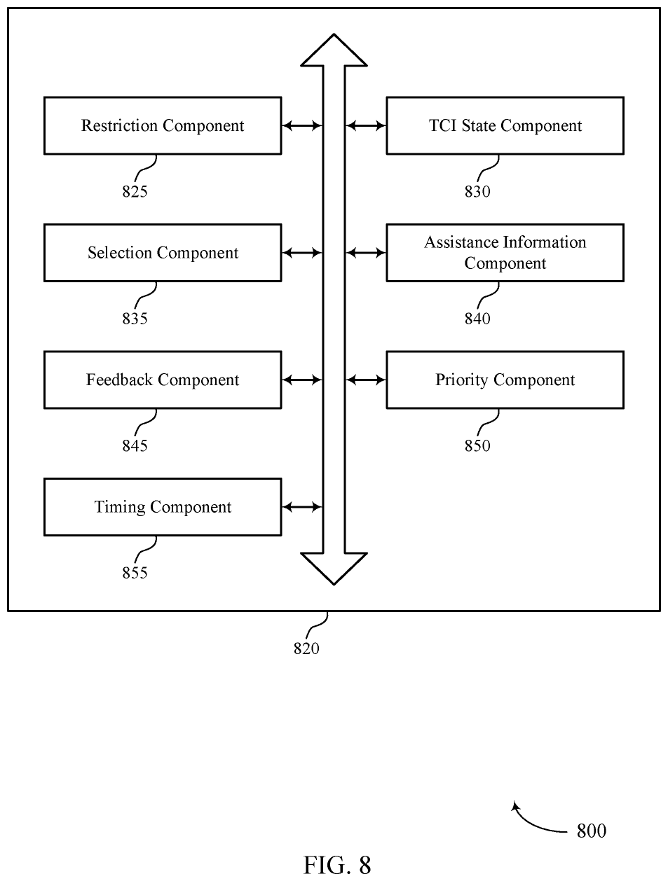

FIG. 8 illustrates a block diagram 800 of a communications manager 820 that supports sidelink TCI state command conflict resolution in accordance with one or more aspects of the present disclosure. The communications manager 820 may be an example of aspects of a communications manager 620, a communications manager 720, or both, as described herein. The communications manager 820, or various components thereof, may be an example of means for performing various aspects of sidelink TCI state command conflict resolution as described herein. For example, the communications manager 820 may include a restriction component 825, a TCI state component 830, a selection component 835, an assistance information component 840, a feedback component 845, a priority component 850, a timing component 855, or any combination thereof. Each of these components may communicate, directly or indirectly, with one another (e.g., via one or more buses).

The communications manager 820 may support wireless communications at a first UE in accordance with examples as disclosed herein. The restriction component 825 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The TCI state component 830 may be configured as or otherwise support a means for transmitting, to the second UE, an indication of a first TCI state in accordance with the limitation. In some examples, the TCI state component 830 may be configured as or otherwise support a means for communicating with the second UE in accordance with the first TCI state.

In some examples, the limitation defines that only one of the first UE or the second UE is to transmit the potential TCI state.

In some examples, the assistance information component 840 may be configured as or otherwise support a means for receiving, from the second UE, an indication of assistance information associated with the sidelink communications between the first UE and the second UE. In some examples, the TCI state component 830 may be configured as or otherwise support a means for determining the first TCI state based on the assistance information.

In some examples, the restriction component 825 may be configured as or otherwise support a means for determining that a type of the first UE matches a designated UE type specified by the limitation, the designated UE type representative of UEs allowed to transmit the potential TCI state in accordance with the limitation.

In some examples, the designated UE type is a RSU or a PLC.

In some examples, the limitation defines that all potential TCI states used during the sidelink communications have a same time threshold for application of the potential TCI states.

In some examples, the feedback component 845 may be configured as or otherwise support a means for receiving, from the second UE, an acknowledgement message associated with the indication from the first UE of the first TCI state. In some examples, the TCI state component 830 may be configured as or otherwise support a means for applying the first TCI state to the sidelink communications with the second UE after receipt of the acknowledgement message and after the time threshold.

In some examples, the time threshold is defined in the first control information as a quantity of symbols that follows receipt of an acknowledgement message responsive to transmission of the indication of the first TCI state.

In some examples, the TCI state component 830 may be configured as or otherwise support a means for receiving, from the second UE, a second indication of a second TCI state. In some examples, the feedback component 845 may be configured as or otherwise support a means for transmitting, to the second UE, a second acknowledgement message associated with the second indication from the second UE of the second TCI state. In some examples, the TCI state component 830 may be configured as or otherwise support a means for communicating with the second UE in accordance with the second TCI state after transmission of the second acknowledgement message and after the time threshold.

In some examples, to support communicating with the second UE in accordance with the second TCI state, the TCI state component 830 may be configured as or otherwise support a means for switching from communicating in accordance with the first TCI state to communicating in accordance with the second TCI state.

In some examples, the first UE communicates according to a time division multiplexing communication scheme.

Additionally, or alternatively, the communications manager 820 may support wireless communications at a first UE in accordance with examples as disclosed herein. In some examples, the restriction component 825 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. In some examples, the TCI state component 830 may be configured as or otherwise support a means for receiving, from the first UE, an indication of a first TCI state in accordance with the limitation. In some examples, the TCI state component 830 may be configured as or otherwise support a means for communicating with the first UE in accordance with the first TCI state.

In some examples, the limitation defines that only one of the first UE or the second UE is to transmit the potential TCI state.

In some examples, the assistance information component 840 may be configured as or otherwise support a means for transmitting, to the second UE, an indication of assistance information associated with the sidelink communications between the first UE and the second UE.

In some examples, the limitation defines that all potential TCI states used during the sidelink communications have a same time threshold for application of the potential TCI states.

In some examples, the feedback component 845 may be configured as or otherwise support a means for transmitting, to the second UE, an acknowledgement message associated with the indication from the second UE of first TCI state. In some examples, the TCI state component 830 may be configured as or otherwise support a means for applying the first TCI state to the sidelink communications with the second UE after transmission of the acknowledgement message and after the time threshold.

In some examples, the time threshold is defined in the first control information as a quantity of symbols that follows receipt of an acknowledgement message responsive to transmission of the indication of the first TCI state.

In some examples, the TCI state component 830 may be configured as or otherwise support a means for transmitting, to the second UE, a second indication of a second TCI state. In some examples, the feedback component 845 may be configured as or otherwise support a means for receiving, from the second UE, a second acknowledgement message associated with the second indication from the first UE of the second TCI state. In some examples, the TCI state component 830 may be configured as or otherwise support a means for communicating with the second UE in accordance with the second TCI state after transmission of the second acknowledgement message and after the time threshold.

In some examples, to support communicating with the first UE in accordance with the second TCI state, the TCI state component 830 may be configured as or otherwise support a means for switching from communicating in accordance with the first TCI state to communicating in accordance with the second TCI state.

In some examples, the first UE communicates according to a time division multiplexing communication scheme.

Additionally, or alternatively, the communications manager 820 may support wireless communications at a first UE in accordance with examples as disclosed herein. In some examples, the TCI state component 830 may be configured as or otherwise support a means for transmitting, to a second UE, first control information that indicates a first TCI state for use in sidelink communications between the first UE and the second UE. In some examples, the TCI state component 830 may be configured as or otherwise support a means for receiving, from the second UE, second control information that indicates a second TCI state for use in the sidelink communications between the first UE and the second UE, where a first application time of the first TCI state conflicts with a second application time of the second TCI state. The selection component 835 may be configured as or otherwise support a means for selecting, in accordance with one or more rules for resolving sidelink TCI state conflicts, one of the first TCI state or the second TCI state as a selected TCI state. In some examples, the TCI state component 830 may be configured as or otherwise support a means for communicating with the second UE in accordance with the selected TCI state.

In some examples, the one or more rules define that the selected TCI state is selected, by the first UE, based on a comparison of a first priority associated with the first UE and a second priority associated with the second UE.

In some examples, to support selecting one of the first TCI state or the second TCI state as the selected TCI state, the priority component 850 may be configured as or otherwise support a means for comparing the first priority and the second priority. In some examples, to support selecting one of the first TCI state or the second TCI state as the selected TCI state, the selection component 835 may be configured as or otherwise support a means for determining the selected TCI state from the first TCI state or the second TCI state that was transmitted by the first UE or the second UE, respectively, that corresponds with a highest priority between the first priority and the second priority.

In some examples, the first priority and the second priority are based on a UE type of the first UE and the second UE, respectively.

In some examples, the UE type of the highest priority is a hub UE, a RSU, or a PLC.

In some examples, the first priority and the second priority are based on a quality of channel knowledge of the first UE and the second UE, respectively.

In some examples, the quality of channel knowledge is based in part on at least one of an update frequency of a CSI-RS beam codebook or a degree of refinement of the CSI-RS beam codebook.

In some examples, the first priority and the second priority are based on a TCI state command type of the first control information of the first UE and of the second control information of the second UE, respectively.

In some examples, the TCI state command type of the highest priority is a TCI state command that includes a request to set a transmit beam.

In some examples, the first priority and the second priority are based on a UE role of the first UE and the second UE, respectively, in the sidelink communications.

In some examples, the UE role of the highest priority is a transmitter UE when the sidelink communications are one-directional.

In some examples, the one or more rules define that the selected TCI state is selected, by the first UE, based on a comparison of a first timing of a first acknowledgement message received in response to the first control information indicating the first TCI state and a second timing of a second acknowledgement message transmitted in response to the second control information indicating the second TCI state.

In some examples, to support selecting one of the first TCI state or the second TCI state as the selected TCI state, the timing component 855 may be configured as or otherwise support a means for comparing the first timing and the second timing. In some examples, to support selecting one of the first TCI state or the second TCI state as the selected TCI state, the selection component 835 may be configured as or otherwise support a means for determining the selected TCI state from the first TCI state or the second TCI state that was transmitted by the first UE or the second UE, respectively, that corresponds with an earliest of the first timing and the second timing.

In some examples, to support selecting one of the first TCI state or the second TCI state as the selected TCI state, the timing component 855 may be configured as or otherwise support a means for comparing the first timing and the second timing. In some examples, to support selecting one of the first TCI state or the second TCI state as the selected TCI state, the selection component 835 may be configured as or otherwise support a means for determining the selected TCI state from the first TCI state or the second TCI state that was transmitted by the first UE or the second UE, respectively, that corresponds with a latest of the first timing and the second timing.

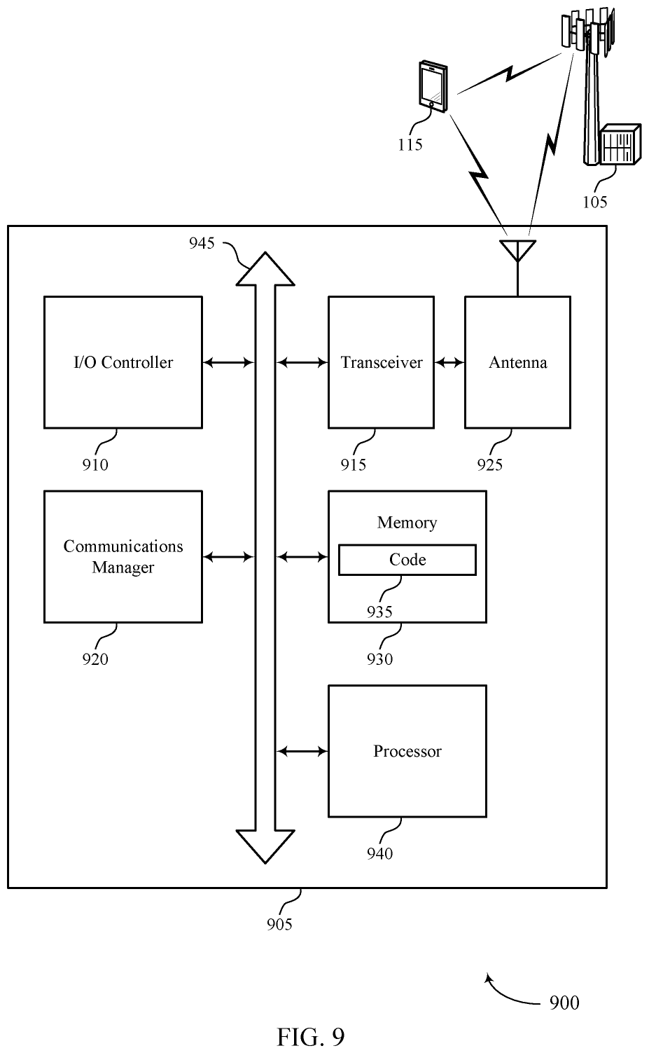

FIG. 9 illustrates a diagram of a system 900 including a device 905 that supports sidelink TCI state command conflict resolution in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting sidelink TCI state command conflict resolution). For example, the device 905 or a component of the device 905 may include a processor 940 and memory 930 coupled with or to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The communications manager 920 may be configured as or otherwise support a means for transmitting, to the second UE, an indication of a first TCI state in accordance with the limitation. The communications manager 920 may be configured as or otherwise support a means for communicating with the second UE in accordance with the first TCI state.

Additionally, or alternatively, the communications manager 920 may support wireless communications at a first UE in accordance with examples as disclosed herein. For example, the communications manager 920 may be configured as or otherwise support a means for receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The communications manager 920 may be configured as or otherwise support a means for receiving, from the first UE, an indication of a first TCI state in accordance with the limitation. The communications manager 920 may be configured as or otherwise support a means for communicating with the first UE in accordance with the first TCI state.

Additionally, or alternatively, the communications manager 920 may support wireless communications at a first UE in accordance with examples as disclosed herein. For example, the communications manager 920 may be configured as or otherwise support a means for transmitting, to a second UE, first control information that indicates a first TCI state for use in sidelink communications between the first UE and the second UE. The communications manager 920 may be configured as or otherwise support a means for receiving, from the second UE, second control information that indicates a second TCI state for use in the sidelink communications between the first UE and the second UE, where a first application time of the first TCI state conflicts with a second application time of the second TCI state. The communications manager 920 may be configured as or otherwise support a means for selecting, in accordance with one or more rules for resolving sidelink TCI state conflicts, one of the first TCI state or the second TCI state as a selected TCI state. The communications manager 920 may be configured as or otherwise support a means for communicating with the second UE in accordance with the selected TCI state.

By including or configuring the communications manager 920 in accordance with examples as described herein, the device 905 may support techniques for TCI state command conflict resolution in sidelink communications which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of sidelink TCI state command conflict resolution as described herein, or the processor 940 and the memory 930 may be otherwise configured to perform or support such operations.

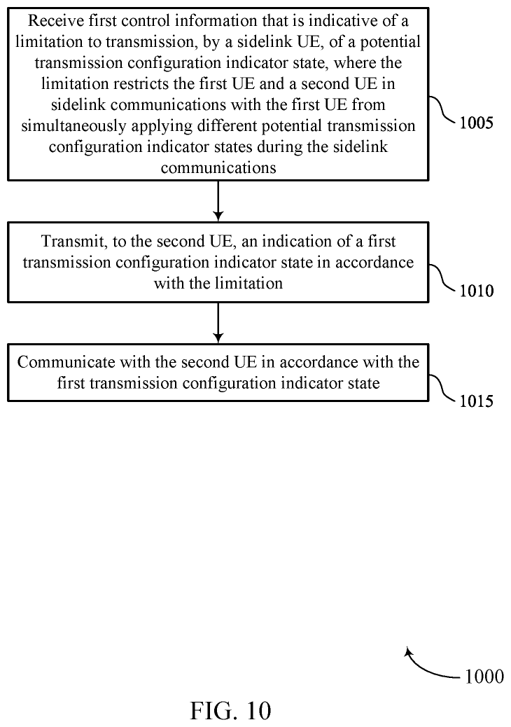

FIG. 10 illustrates a flowchart showing a method 1000 that supports sidelink TCI state command conflict resolution in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The operations of 1005 may be performed in accordance with examples as disclosed herein. In some examples, aspects of the operations of 1005 may be performed by a restriction component 825 as described with reference to FIG. 8.

At 1010, the method may include transmitting, to the second UE, an indication of a first TCI state in accordance with the limitation. The operations of 1010 may be performed in accordance with examples as disclosed herein. In some examples, aspects of the operations of 1010 may be performed by a TCI state component 830 as described with reference to FIG. 8.

At 1015, the method may include communicating with the second UE in accordance with the first TCI state. The operations of 1015 may be performed in accordance with examples as disclosed herein. In some examples, aspects of the operations of 1015 may be performed by a TCI state component 830 as described with reference to FIG. 8.

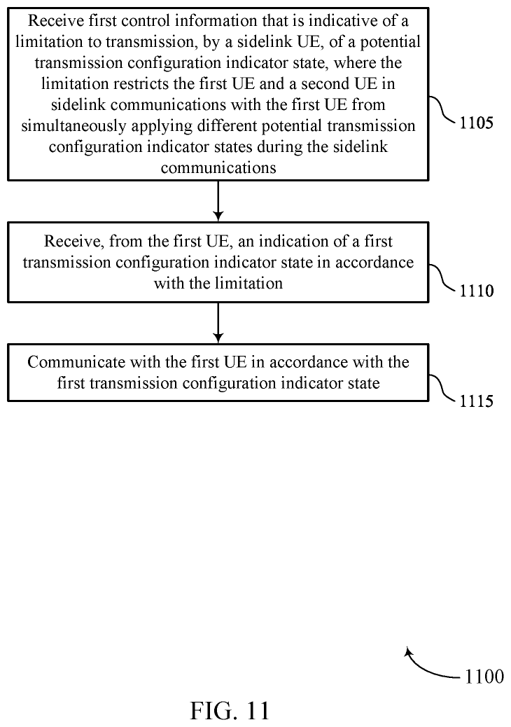

FIG. 11 illustrates a flowchart showing a method 1100 that supports sidelink TCI state command conflict resolution in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving first control information that is indicative of a limitation to transmission, by a sidelink UE, of a potential TCI state, where the limitation restricts the first UE and a second UE in sidelink communications with the first UE from simultaneously applying different potential TCI states during the sidelink communications. The operations of 1105 may be performed in accordance with examples as disclosed herein. In some examples, aspects of the operations of 1105 may be performed by a restriction component 825 as described with reference to FIG. 8.

At 1110, the method may include receiving, from the first UE, an indication of a first TCI state in accordance with the limitation. The operations of 1110 may be performed in accordance with examples as disclosed herein. In some examples, aspects of the operations of 1110 may be performed by a TCI state component 830 as described with reference to FIG. 8.

At 1115, the method may include communicating with the first UE in accordance with the first TCI state. The operations of 1115 may be performed in accordance with examples as disclosed herein. In some examples, aspects of the operations of 1115 may be performed by a TCI state component 830 as described with reference to FIG. 8.

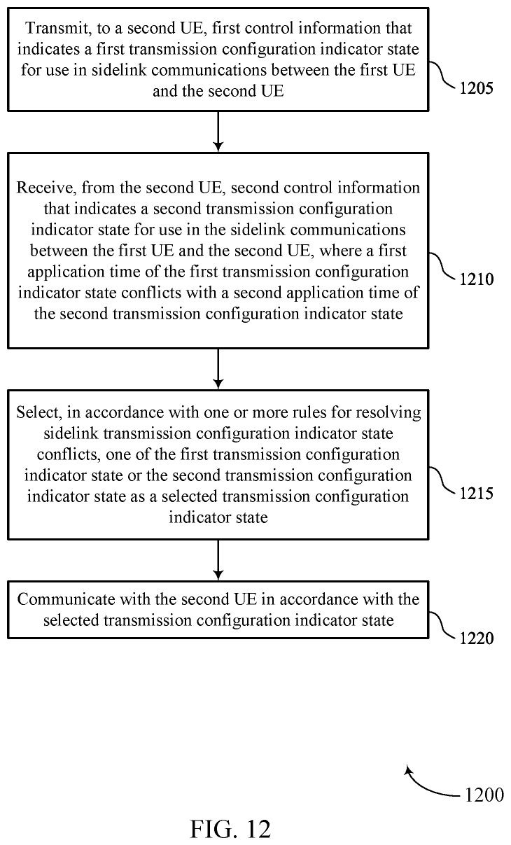

FIG. 12 illustrates a flowchart showing a method 1200 that supports sidelink TCI state command conflict resolution in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include transmitting, to a second UE, first control information that indicates a first TCI state for use in sidelink communications between the first UE and the second UE. The operations of 1205 may be performed in accordance with examples as disclosed herein. In some examples, aspects of the operations of 1205 may be performed by a TCI state component 830 as described with reference to FIG. 8.

At 1210, the method may include receiving, from the second UE, second control information that indicates a second TCI state for use in the sidelink communications between the first UE and the second UE, where a first application time of the first TCI state conflicts with a second application time of the second TCI state. The operations of 1210 may be performed in accordance with examples as disclosed herein. In some examples, aspects of the operations of 1210 may be performed by a TCI state component 830 as described with reference to FIG. 8.

At 1215, the method may include selecting, in accordance with one or more rules for resolving sidelink TCI state conflicts, one of the first TCI state or the second TCI state as a selected TCI state. The operations of 1215 may be performed in accordance with examples as disclosed herein. In some examples, aspects of the operations of 1215 may be performed by a selection component 835 as described with reference to FIG. 8.

At 1220, the method may include communicating with the second UE in accordance with the selected TCI state. The operations of 1220 may be performed in accordance with examples as disclosed herein. In some examples, aspects of the operations of 1220 may be performed by a TCI state component 830 as described with reference to FIG. 8.

The following provides an overview of aspects of the present disclosure:

Aspect 1: A method for wireless communications at a first UE, comprising: receiving first control information that is indicative of a limitation to transmission, by a sidelink UE, of a potential TCI state, wherein the limitation restricts the first UE and a second UE in sidelink communications with the first UE from simultaneously applying different potential transmission configuration states during the sidelink communications; transmitting, to the second UE, an indication of a first TCI state in accordance with the limitation; and communicating with the second UE in accordance with the first TCI state.

Aspect 2: The method of aspect 1, wherein the limitation defines that only one of the first UE or the second UE is to transmit the potential TCI state.

Aspect 3: The method of aspect 2, further comprising: receiving, from the second UE, an indication of assistance information associated with the sidelink communications between the first UE and the second UE; and determining the first TCI state based at least in part on the assistance information.

Aspect 4: The method of any of aspects 2 through 3, further comprising: determining that a type of the first UE matches a designated UE type specified by the limitation, the designated UE type representative of UEs allowed to transmit the potential TCI state in accordance with the limitation.

Aspect 5: The method of aspect 4, wherein the designated UE type is a RSU or a PLC.

Aspect 6: The method of aspect 1, wherein the limitation defines that all potential TCI states used during the sidelink communications have a same time threshold for application of the potential TCI states.

Aspect 7: The method of aspect 6, further comprising: receiving, from the second UE, an acknowledgement message associated with the indication from the first UE of the first TCI state; and applying the first TCI state to the sidelink communications with the second UE after receipt of the acknowledgement message and after the time threshold.

Aspect 8: The method of any of aspects 6 through 7, wherein the time threshold is defined in the first control information as a quantity of symbols that follows receipt of an acknowledgement message responsive to transmission of the indication of the first TCI state.

Aspect 9: The method of any of aspects 6 through 8, further comprising: receiving, from the second UE, a second indication of a second TCI state; transmitting, to the second UE, a second acknowledgement message associated with the second indication from the second UE of the second TCI state; and communicating with the second UE in accordance with the second TCI state after transmission of the second acknowledgement message and after the time threshold.

Aspect 10: The method of aspect 9, wherein communicating with the second UE in accordance with the second TCI state comprises: switching from communicating in accordance with the first TCI state to communicating in accordance with the second TCI state.

Aspect 11: The method of any of aspects 6 through 10, wherein the first UE communicates according to a TDM communication scheme.

Aspect 12: A method for wireless communications at a first UE, comprising: receiving first control information that is indicative of a limitation to transmission, by a sidelink UE, of a potential TCI state, wherein the limitation restricts the first UE and a second UE in sidelink communications with the first UE from simultaneously applying different potential transmission configuration states during the sidelink communications; receiving, from the first UE, an indication of a first TCI state in accordance with the limitation; and communicating with the first UE in accordance with the first TCI state.

Aspect 13: The method of aspect 12, wherein the limitation defines that only one of the first UE or the second UE is to transmit the potential TCI state.

Aspect 14: The method of aspect 13, further comprising: transmitting, to the second UE, an indication of assistance information associated with the sidelink communications between the first UE and the second UE.

Aspect 15: The method of aspect 12, wherein the limitation defines that all potential TCI states used during the sidelink communications have a same time threshold for application of the potential TCI states.

Aspect 16: The method of aspect 15, further comprising: transmitting, to the second UE, an acknowledgement message associated with the indication from the second UE of first TCI state; and applying the first TCI state to the sidelink communications with the second UE after transmission of the acknowledgement message and after the time threshold.

Aspect 17: The method of any of aspects 15 through 16, wherein the time threshold is defined in the first control information as a quantity of symbols that follows receipt of an acknowledgement message responsive to transmission of the indication of the first TCI state.

Aspect 18: The method of any of aspects 15 through 17, further comprising: transmitting, to the second UE, a second indication of a second TCI state; receiving, from the second UE, a second acknowledgement message associated with the second indication from the first UE of the second TCI state; and communicating with the second UE in accordance with the second TCI state after transmission of the second acknowledgement message and after the time threshold.

Aspect 19: The method of aspect 18, wherein communicating with the first UE in accordance with the second TCI state comprises: switching from communicating in accordance with the first TCI state to communicating in accordance with the second TCI state.

Aspect 20: The method of any of aspects 15 through 19, wherein the first UE communicates according to a TDM communication scheme.

Aspect 21: A method for wireless communications at a first UE, comprising: transmitting, to a second UE, first control information that indicates a first TCI state for use in sidelink communications between the first UE and the second UE; receiving, from the second UE, second control information that indicates a second TCI state for use in the sidelink communications between the first UE and the second UE, wherein a first application time of the first TCI state conflicts with a second application time of the second TCI state; selecting, in accordance with one or more rules for resolving sidelink TCI state conflicts, one of the first TCI state or the second TCI state as a selected TCI state; and communicating with the second UE in accordance with the selected TCI state.

Aspect 22: The method of aspect 21, wherein the one or more rules define that the selected TCI state is selected, by the first UE, based at least in part on a comparison of a first priority associated with the first UE and a second priority associated with the second UE.

Aspect 23: The method of aspect 22, wherein selecting one of the first TCI state or the second TCI state as the selected TCI state further comprises: comparing the first priority and the second priority; and determining the selected TCI state from the first TCI state or the second TCI state that was transmitted by the first UE or the second UE, respectively, that corresponds with a highest priority between the first priority and the second priority.

Aspect 24: The method of aspect 23, wherein the first priority and the second priority are based on a UE type of the first UE and the second UE, respectively.

Aspect 25: The method of aspect 24, wherein the UE type of the highest priority is a hub UE, a RSU, or a PLC.

Aspect 26: The method of any of aspects 23 through 25, wherein the first priority and the second priority are based on a quality of channel knowledge of the first UE and the second UE, respectively.

Aspect 27: The method of aspect 26, wherein the quality of channel knowledge is based in part on at least one of an update frequency of a CSI-RS beam codebook or a degree of refinement of the CSI-RS beam codebook.

Aspect 28: The method of any of aspects 23 through 27, wherein the first priority and the second priority are based on a TCI state command type of the first control information of the first UE and of the second control information of the second UE, respectively.

Aspect 29: The method of aspect 28, wherein the TCI state command type of the highest priority is a TCI state command that includes a request to set a transmit beam.

Aspect 30: The method of any of aspects 23 through 29, wherein the first priority and the second priority are based on a UE role of the first UE and the second UE, respectively, in the sidelink communications.

Aspect 31: The method of aspect 30, wherein the UE role of the highest priority is a transmitter UE when the sidelink communications are one-directional.

Aspect 32: The method of any of aspects 21 through 31, wherein the one or more rules define that the selected TCI state is selected, by the first UE, based at least in part on a comparison of a first timing of a first acknowledgement message received in response to the first control information indicating the first TCI state and a second timing of a second acknowledgement message transmitted in response to the second control information indicating the second TCI state.

Aspect 33: The method of aspect 32, wherein selecting one of the first TCI state or the second TCI state as the selected TCI state further comprises: comparing the first timing and the second timing; and determining the selected TCI state from the first TCI state or the second TCI state that was transmitted by the first UE or the second UE, respectively, that corresponds with an earliest of the first timing and the second timing.

Aspect 34: The method of aspect 32, wherein selecting one of the first TCI state or the second TCI state as the selected TCI state further comprises: comparing the first timing and the second timing; and determining the selected TCI state from the first TCI state or the second TCI state that was transmitted by the first UE or the second UE, respectively, that corresponds with a latest of the first timing and the second timing.

Aspect 35: An apparatus for wireless communications at a first UE, comprising a processor; memory coupled with the processor; and instructions stored in the memory and executable by the processor to cause the apparatus to perform a method of any of aspects 1 through 11.

Aspect 36: An apparatus for wireless communications at a first UE, comprising at least one means for performing a method of any of aspects 1 through 11.

Aspect 37: A non-transitory computer-readable medium storing code for wireless communications at a first UE, the code comprising instructions executable by a processor to perform a method of any of aspects 1 through 11.

Aspect 38: An apparatus for wireless communications at a first UE, comprising a processor; memory coupled with the processor; and instructions stored in the memory and executable by the processor to cause the apparatus to perform a method of any of aspects 12 through 20.

Aspect 39: An apparatus for wireless communications at a first UE, comprising at least one means for performing a method of any of aspects 12 through 20.

Aspect 40: A non-transitory computer-readable medium storing code for wireless communications at a first UE, the code comprising instructions executable by a processor to perform a method of any of aspects 12 through 20.

Aspect 41: An apparatus for wireless communications at a first UE, comprising a processor; memory coupled with the processor; and instructions stored in the memory and executable by the processor to cause the apparatus to perform a method of any of aspects 21 through 34.

Aspect 42: An apparatus for wireless communications at a first UE, comprising at least one means for performing a method of any of aspects 21 through 34.

Aspect 43: A non-transitory computer-readable medium storing code for wireless communications at a first UE, the code comprising instructions executable by a processor to perform a method of any of aspects 21 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
transmitting, to a second UE, first control information that indicates a first transmission configuration indicator state for use in sidelink communications between the first UE and the second UE;
receiving, from the second UE, second control information that indicates a second transmission configuration indicator state for use in the sidelink communications between the first UE and the second UE, wherein a first application time of the first transmission configuration indicator state conflicts with a second application time of the second transmission configuration indicator state;
selecting, in accordance with one or more rules for resolving sidelink transmission configuration indicator state conflicts, one of the first transmission configuration indicator state or the second transmission configuration indicator state as a selected transmission configuration indicator state; and
communicating with the second UE in accordance with the selected transmission configuration indicator state.

2. The method of claim 1, wherein the one or more rules define that the selected transmission configuration indicator state is selected, by the first UE, based at least in part on a comparison of a first priority associated with the first UE and a second priority associated with the second UE.

3. The method of claim 2, wherein selecting one of the first transmission configuration indicator state or the second transmission configuration indicator state as the selected transmission configuration indicator state further comprises:
comparing the first priority and the second priority; and
determining the selected transmission configuration indicator state from the first transmission configuration indicator state or the second transmission configuration indicator state that was transmitted by the first UE or the second UE, respectively, that corresponds with a highest priority between the first priority and the second priority.

4. The method of claim 3, wherein the first priority and the second priority are based on a UE type of the first UE and the second UE, respectively.

5. The method of claim 4, wherein the UE type of the highest priority is a hub UE, a roadside unit, or a programmable logic controller.

6. The method of claim 3, wherein the first priority and the second priority are based on a quality of channel knowledge of the first UE and the second UE, respectively.

7. The method of claim 6, wherein the quality of channel knowledge is based in part on at least one of an update frequency of a channel state information reference signal (CSI-RS) beam codebook or a degree of refinement of the CSI-RS beam codebook.

8. The method of claim 3, wherein the first priority and the second priority are based on a transmission configuration indicator state command type of the first control information of the first UE and of the second control information of the second UE, respectively.

9. The method of claim 8, wherein the transmission configuration indicator state command type of the highest priority is a transmission configuration indicator state command that includes a request to set a transmit beam.

10. The method of claim 3, wherein the first priority and the second priority are based on a UE role of the first UE and the second UE, respectively, in the sidelink communications.

11. The method of claim 10, wherein the UE role of the highest priority is a transmitter UE when the sidelink communications are one-directional.

12. The method of claim 1, wherein the one or more rules define that the selected transmission configuration indicator state is selected, by the first UE, based at least in part on a comparison of a first timing of a first acknowledgement message received in response to the first control information indicating the first transmission configuration indicator state and a second timing of a second acknowledgement message transmitted in response to the second control information indicating the second transmission configuration indicator state.

13. The method of claim 12, wherein selecting one of the first transmission configuration indicator state or the second transmission configuration indicator state as the selected transmission configuration indicator state further comprises:
comparing the first timing and the second timing; and
determining the selected transmission configuration indicator state from the first transmission configuration indicator state or the second transmission configuration indicator state that was transmitted by the first UE or the second UE, respectively, that corresponds with an earliest of the first timing and the second timing.

14. The method of claim 12, wherein selecting one of the first transmission configuration indicator state or the second transmission configuration indicator state as the selected transmission configuration indicator state further comprises:
comparing the first timing and the second timing; and
determining the selected transmission configuration indicator state from the first transmission configuration indicator state or the second transmission configuration indicator state that was transmitted by the first UE or the second UE, respectively, that corresponds with a latest of the first timing and the second timing.

15. An apparatus for wireless communications at a first user equipment (UE), comprising:
a processor;
memory coupled with the processor; and
instructions stored in the memory and executable by the processor to cause the apparatus to:
transmit, to a second UE, first control information that indicates a first transmission configuration indicator state for use in sidelink communications between the first UE and the second UE;
receive, from the second UE, second control information that indicates a second transmission configuration indicator state for use in the sidelink communications between the first UE and the second UE, wherein a first application time of the first transmission configuration indicator state conflicts with a second application time of the second transmission configuration indicator state;
select, in accordance with one or more rules for resolving sidelink transmission configuration indicator state conflicts, one of the first transmission configuration indicator state or the second transmission configuration indicator state as a selected transmission configuration indicator state; and
communicate with the second UE in accordance with the selected transmission configuration indicator state.

16. The apparatus of claim 15, wherein the one or more rules define that the selected transmission configuration indicator state is selected, by the first UE, based at least in part on a comparison of a first priority associated with the first UE and a second priority associated with the second UE.

17. The apparatus of claim 16, wherein the instructions to select one of the first transmission configuration indicator state or the second transmission configuration indicator state as the selected transmission configuration indicator state are further executable by the processor to cause the apparatus to:
compare the first priority and the second priority; and
determine the selected transmission configuration indicator state from the first transmission configuration indicator state or the second transmission configuration indicator state that was transmitted by the first UE or the second UE, respectively, that corresponds with a highest priority between the first priority and the second priority.

18. The apparatus of claim 17, wherein the first priority and the second priority are based on a UE type of the first UE and the second UE, respectively.

19. The apparatus of claim 18, wherein the UE type of the highest priority is a hub UE, a roadside unit, or a programmable logic controller.

20. The apparatus of claim 17, wherein the first priority and the second priority are based on a quality of channel knowledge of the first UE and the second UE, respectively.

21. The apparatus of claim 20, wherein the quality of channel knowledge is based in part on at least one of an update frequency of a channel state information reference signal (CSI-RS) beam codebook or a degree of refinement of the CSI-RS beam codebook.

22. The apparatus of claim 17, wherein the first priority and the second priority are based on a transmission configuration indicator state command type of the first control information of the first UE and of the second control information of the second UE, respectively.

23. The apparatus of claim 22, wherein the transmission configuration indicator state command type of the highest priority is a transmission configuration indicator state command that includes a request to set a transmit beam.

24. The apparatus of claim 17, wherein the first priority and the second priority are based on a UE role of the first UE and the second UE, respectively, in the sidelink communications.

25. The apparatus of claim 24, wherein the UE role of the highest priority is a transmitter UE when the sidelink communications are one-directional.

26. The apparatus of claim 15, wherein the one or more rules define that the selected transmission configuration indicator state is selected, by the first UE, based at least in part on a comparison of a first timing of a first acknowledgement message received in response to the first control information indicating the first transmission configuration indicator state and a second timing of a second acknowledgement message transmitted in response to the second control information indicating the second transmission configuration indicator state.

27. The apparatus of claim 26, wherein the instructions to select one of the first transmission configuration indicator state or the second transmission configuration indicator state as the selected transmission configuration indicator state are further executable by the processor to cause the apparatus to:
compare the first timing and the second timing; and
determine the selected transmission configuration indicator state from the first transmission configuration indicator state or the second transmission configuration indicator state that was transmitted by the first UE or the second UE, respectively, that corresponds with an earliest of the first timing and the second timing.

28. The apparatus of claim 26, wherein the instructions to select one of the first transmission configuration indicator state or the second transmission configuration indicator state as the selected transmission configuration indicator state are further executable by the processor to cause the apparatus to:
compare the first timing and the second timing; and
determine the selected transmission configuration indicator state from the first transmission configuration indicator state or the second transmission configuration indicator state that was transmitted by the first UE or the second UE, respectively, that corresponds with a latest of the first timing and the second timing.

29. An apparatus for wireless communications at a first user equipment (UE), comprising:
means for transmitting, to a second UE, first control information that indicates a first transmission configuration indicator state for use in sidelink communications between the first UE and the second UE;
means for receiving, from the second UE, second control information that indicates a second transmission configuration indicator state for use in the sidelink communications between the first UE and the second UE, wherein a first application time of the first transmission configuration indicator state conflicts with a second application time of the second transmission configuration indicator state;
means for selecting, in accordance with one or more rules for resolving sidelink transmission configuration indicator state conflicts, one of the first transmission configuration indicator state or the second transmission configuration indicator state as a selected transmission configuration indicator state; and
means for communicating with the second UE in accordance with the selected transmission configuration indicator state.

30. A non-transitory computer-readable medium storing code for wireless communications at a first user equipment (UE), the code comprising instructions executable by a processor to:
transmit, to a second UE, first control information that indicates a first transmission configuration indicator state for use in sidelink communications between the first UE and the second UE;
receive, from the second UE, second control information that indicates a second transmission configuration indicator state for use in the sidelink communications between the first UE and the second UE, wherein a first application time of the first transmission configuration indicator state conflicts with a second application time of the second transmission configuration indicator state;
select, in accordance with one or more rules for resolving sidelink transmission configuration indicator state conflicts, one of the first transmission configuration indicator state or the second transmission configuration indicator state as a selected transmission configuration indicator state; and
communicate with the second UE in accordance with the selected transmission configuration indicator state.
